(19) United States
(12) Patent Application Publication
(10) Pub. No.: US 2002/0035731 A1
(43) Pub. Date: Mar. 21, 2002

(54) System and method for broadcasting information in a television distribution system

(76) Inventors: Bruce Plotnick, Jamison, PA (US); Joseph E. Augenbraun, Princeton, NJ (US); Randell E. Jesup, Downington, PA (US); Michael Mathiesen, Yardley, PA (US); Errol J. D'Souza, Sicklerville, NJ (US)

Correspondence Address: William A. Blake, Jones, Tullar & Cooper, P.C., P.O. Box 2266 Eads Station, Arlington, VA, 22202, US

(21) Appl. No.: 09/850,146

(22) Filed: May 8, 2001

Related U.S. Application Data
(60) Provisional application No. 60/202,820, filed on May 8, 2000.

(51) Int. Cl. H04N 7/16; H04N 7/173

(52) U.S. Cl. 725/146; 725/145; 725/116; 725/93

(57) ABSTRACT

A national level information service system collects local and national interest information and advertisements from a plurality of remote providers that may be located around the country or the world, and distributes this information to one or more television distribution systems for viewing by the system viewers. The system provides timely information relating to various areas of interest, including, for example, news, sports, weather, stock information and the like, that can be viewed on one or more television channels. Providers of the national and local interest information periodically collect the raw data containing the information to be broadcast, and store the data at a designated location, preferably on the provider's Internet server. These stored files are then periodically retrieved and compared to previously retrieved files to determine whether they have been updated by the information provider. Any updated files are sent to a central server that provides information data storage for a plurality of channels, each of which is assigned to a particular information provider. The central server periodically checks to see if new data has arrived for any of the channels, and if so, the data is formatted into script pages (e.g., HTML) that are suitable for display and sends the script pages to one or more local television distribution systems for broadcast to the system viewers.

### PRIORITY CLAIM UNDER 35 U.S.C. 119 (e)

This application claims the benefit, under 35 U.S.C. 119 (e), of U.S. Provisional Application No. 60/202,820, filed May 8, 2000.

### BACKGROUND OF THE INVENTION

1. Field of the Invention

The present invention relates in general to a system and method for broadcasting information from a plurality of providers over a television distribution system, or the like. More particularly, the present invention relates to a system and method for periodically collecting data from various providers of local and national interest information, and transferring and formatting the data for display on a viewer's television.

2. Description of the Background Art

In known television distribution systems, including satellite-based and cable-based systems, for example, upwards of a hundred or more channels are often broadcast to the viewers. Typically, some of these channels are not employed for broadcasting conventional television programs, but instead are employed for broadcasting static screens of information pertaining to areas of local or national interest. Examples of the types of information that may be broadcast on these channels include weather conditions, traffic conditions, local community information, airline flight status information, etc. Such information is typically supplied locally by the television distribution system (e.g., CATV provider) or the like, and is periodically updated by the provider as necessary. To date, these types of systems have been limited to use with information that is generated by the local television distribution system itself, and a need therefore exists for a system that can provide this type of information on a national level wherein the information providers are remotely located from the television distribution system.

### SUMMARY OF THE INVENTION

The present invention fulfills the foregoing need through provision of a system and method for collecting local interest and national interest information, and advertisements from a plurality of remote providers that may be located around the country, or even the world, and distributing this information to one or more television distribution systems for viewing by the system viewers. Preferably, the invention provides timely information relating to various areas of interest, including, for example, news, sports, weather, stock information and the like, that can be viewed on one or more television channels.

To accomplish this functionality, an information network is employed in which multiple servers communicate with one another in a sequential manner such that the national and local interest information is periodically gathered from a plurality of remotely located providers and is supplied to local televison distribution systems for broadcast to the system viewers. Each of the providers of the national and local interest information collects the raw data containing the information to be broadcast, and stores the data in an accessible location, such as an Internet server assigned to the provider. The information provider updates the stored data on a periodic basis, the updating frequency being dependent on the type of information. These stored files are then periodically retrieved and compared to previously retrieved files by software in the provider server to determine whether they have been updated by the information provider. If they have been updated, the provider server sends the files to an inbox at a central server.

The central server inbox provides information data storage for a plurality of channels, each of which is assigned to a particular information provider. The central server periodically checks the inbox to see if new data has arrived for any of the channels. If new data has been detected, the central server formats the data into script pages (e.g., HTML) that are suitable for display and sends the script pages to one or more local servers, one for each local television distribution system to receive the information.

Each of the local servers forwards the received data files to a headend in the corresponding local televison distribution system, which formats the data as necessary and broadcast the data to the system viewers on one or moire channels. A review process is also preferably implemented by each local server prior to the transfer of the information to the television distribution systems to insure that the information meets standards established, for example, by the central server and/or the television distribution systems. In this regard, the local server also preferably includes formatting software that first converts the received HTML data to an appropriate format (e.g., JPEG) for review by an editor, and then reconverts the data back to HTML format once the information has been approved.

### BRIEF DESCRIPTION OF THE DRAWINGS

The features and advantages of the present invention will become apparent from the following detailed description of a preferred embodiment thereof, taken in conjunction with the accompanying drawings, in which:

FIG. 1 is a schematic illustration of an information service distribution system and corresponding general process flow that comprise a preferred embodiment of the present invention;

FIGS. 2A-2L are illustrations of sample screen captures showing examples of the types of information that can be displayed with the system of the present invention; and

FIG. 3 is a flow chart illustrating the detailed method by which the system of FIG. 1 retrieves, updates, processes and reviews information to be distributed.

### DETAILED DESCRIPTION OF A PREFERRED EMBODIMENT

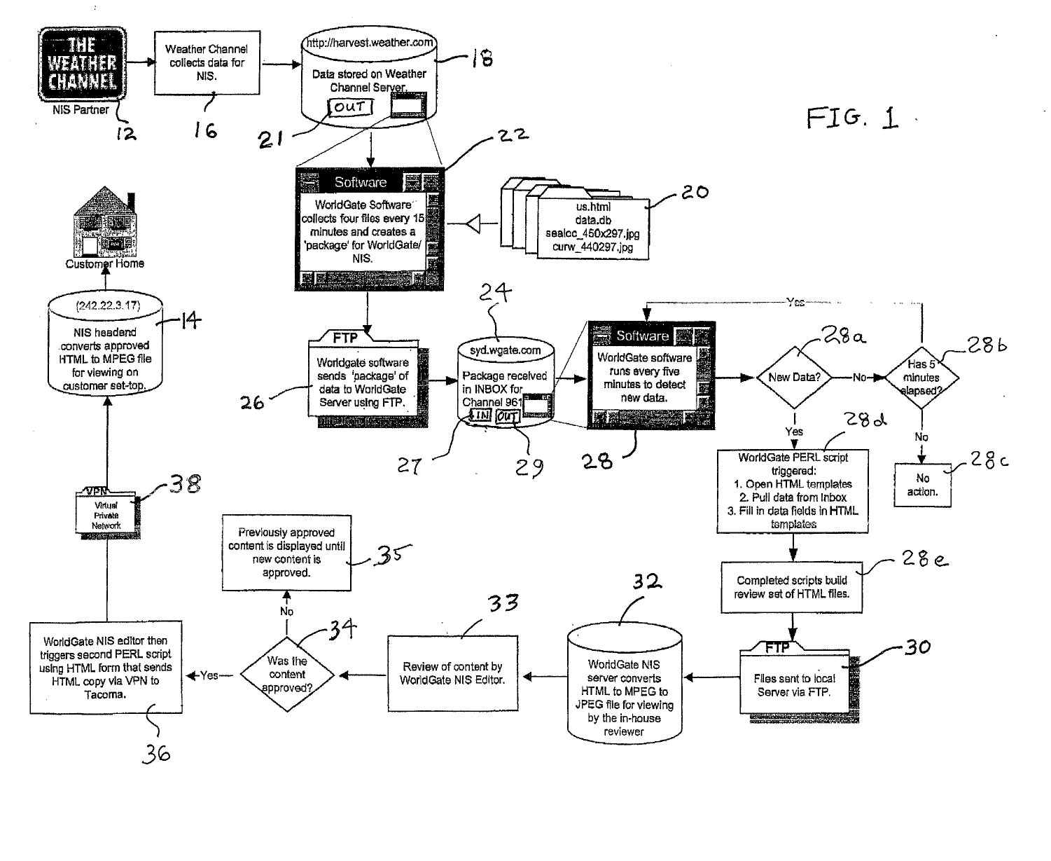

With reference to FIG. 1, an information service distribution system 10 and process flow therefor are illustrated for collecting information from a plurality of information providers (referred to as information service partners), and distributing the information to one or more television distribution systems. In the example illustrated in FIG. 1, a single information provider 12, THE WEATHER CHANNEL, is illustrated. However, it will be understood that numerous providers of information will preferably be employed in the preferred embodiment. Similarly, a single television distribution system, in this example a cable headend 14, is illustrated for receiving the information from the information provider 12. However, it will be understood that in the preferred embodiment, multiple television distribution systems will be able to access the information from the information providers 12.

Each of the information providers 12 is referred to as an “information service partner” because they cooperate with the information service that operates the system 10 by providing the raw data that is necessary to generate the information to be broadcast. As illustrated at 16 in FIG. 1, the information service partner 12 collects the data for the information service, and stores this on a dedicated partner server 18 (e.g., HTTP server) that is accessible through the Internet at the partner's web site. It should be noted that while the Internet is the preferred communications medium for collection and distribution of the information to broadcast, any other suitable form of communications medium, such as wireless, telephone, satellite, dedicated line, etc., could be employed. Also, in the event the partner does not have a web site, the information service data can be stored in a database or other remotely accessible storage medium. In the preferred embodiment, the information service partner 12 assembles pipe delimited text files and image files 20, as needed, along with an index file that contains the complete list of files, and places them in an outbox directory 21 on the dedicated server 18.

The data collected by the information service partner 12 is periodically updated by the partner 12 to keep the information current. For example, in the case of THE WEATHER CHANNEL, current local weather conditions and breaking news would be periodically updated. It should be noted in this regard that at least some of the collected data can be specific to particular regions or areas. As an example, the local weather conditions would obviously be different depending on the location of the television distribution system 14. In this example, local weather condition data for a plurality of local areas would be stored for selective retrieval.

A file retrieval program or other means 22 resides on the partner server 18. Preferably, the file retrieval program 22 periodically, e.g., every 15 minutes, collects the stored data files 20 from the outbox directory 21 and creates a data package to be sent to a central collection server 24 for collection and formatting of all the information service data from each of the partners 12. As indicated at 26, this package is preferably sent using FTP, or any other suitable transfer protocol, to one of a plurality of inboxes 27 in the central server 24 that is designated for the particular information provider 12. Preferably, each of the information service partners 12 is assigned to a dedicated channel and corresponding one of the inboxes 27.

The central server 24 includes a stand alone data detection program 28 which implements the steps indicated at 28a-28e to check each of the inboxes 27 on a periodic basis, e.g., every five minutes, and thereby determine whether new data has arrived from any of the partners 12. Upon detection of updated partner content, the program 28 initiates a script program that combines the raw data from the partner's pipe delimited text files with predefined HTML templates, thereby generating resultant HTML script page files that are saved to an outbox 29 on the central server 24. The script program can be written in any of a number of languages, depending on the selected server platform, and include, for example, PERL, C, VB, PYTHON and JAVA.

The use of a standalone program in the central server 24 is preferred because it separates the page generation tasks from the page serving tasks, thereby limiting the risk of slowing the server down due to resource overload. However, there are two other options that can be employed to perform these tasks: Common Gateway Interface (CGI) and Server Side Scripting. In all three methods, the assumption is made that the data is available from an outside source through FTP or HTTP, is in a delimited format (comma or pipe delimited for example), and that the data is being combined with a template file(s) to generate output. Additionally, success or failure messages to administrators will need to be sent out at any points along the way where knowledge of success or failure is critical, such as checking for existence of data files, checking for success of FTP transfers, etc. If desired, rather than generating HTML output, these methods could also generate GIF's or JPEG's as output to be pulled in on an HTML page, although there would still be need for programming for pushing and pulling files and generating success/failure reports. Using CGI, each http request for a page by the central server 24 would call an executable script, passing parameters (for example, what template to use). The resultant output would be HTML that would display the requested page. Again, any number of programming languages can be used for creating custom CGI's, depending on the server platform. Common languages used for this purpose include PERL, C, JAVA, VB and PYTHON. The same task can be accomplished using Server Side Scripting, such as PHP, ASP or JSP. In this model, each server side page acts as a template in and of itself, and retrieves the data source that it needs. PHP is able to retrieve external files natively, but ASP requires additional components to be added, such as AspHTTP, which is available from <www.serverobjects.com<http://www.serverobjects.com>.

Once the script pages are formed, the program 28 sends the files in the outbox 29 as indicated at 30, preferably via FTP, to a local review server 32, one for each of the cable headends 14. It should be noted that while the script pages are preferably in an HTML format, there are several other options that can be employed to dynamically create an image from data for use in an HTML. These include MACROMEDIA GENERATOR, PHP, PERL, PYTHON, C and JAVA. However, these alternatives would be a lot more computationally involved, and would probably not provide any real advantages over HTML.

The local review server 32 converts the HTML files to MPEG, and then to JPEG files that are capable of being reviewed by an editor at 33. The JPEG files are preferably reviewed for content, to determine whether they will be approved. The purpose of this process is to ensure the information received from the various partners 12 meets the information server standards and the requirements of each of the television distribution systems. It will be understood that while provision of the editor function is preferred, this function may be left out of the system 10 if desired. If the file content is not approved at 34, then the previously approved content continues to be employed for display at 35 until the new content is approved. Once the file content has been approved, the editor triggers a script program at 36 that converts the file content back to HTML format, and forwards the HTML files to the local television distribution system or headend 14 for formatting and downloading to each viewer's set top. A virtual private network 38 is illustrated in FIG. 1 for distributing the HTML information to the headend 14, however, it will once again be understood that any suitable communications media can be used for this purpose.

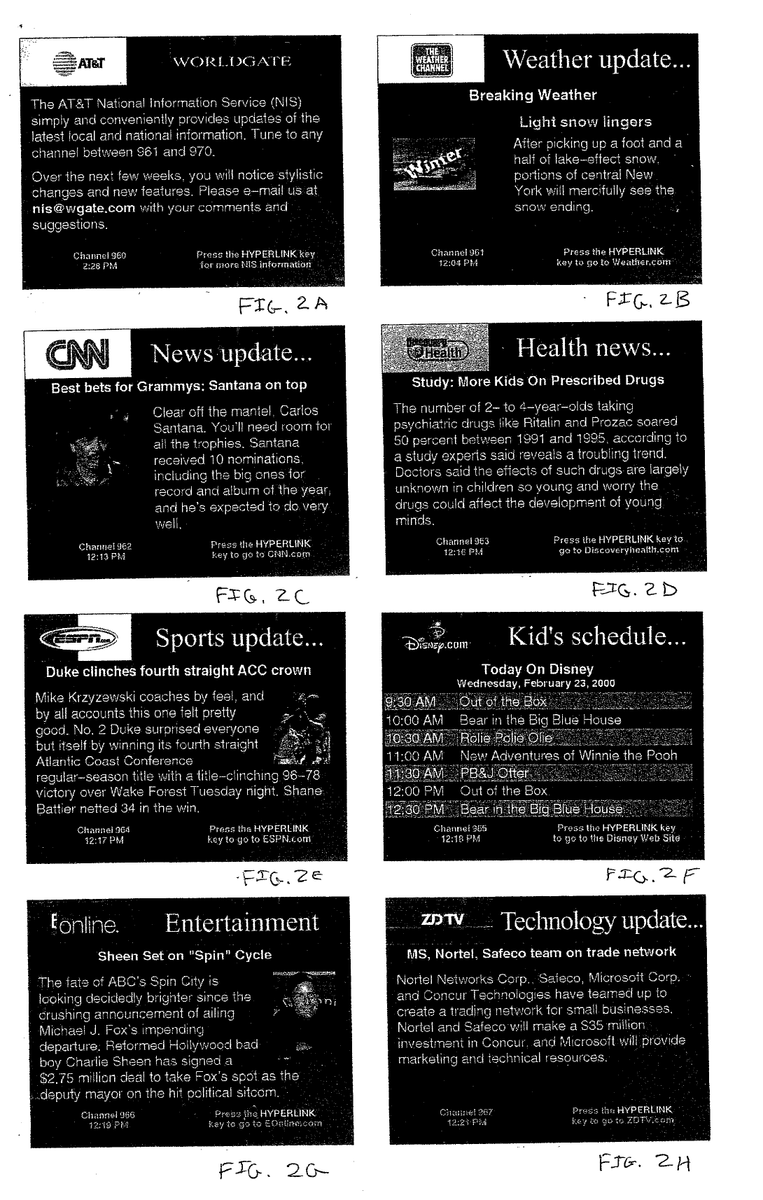

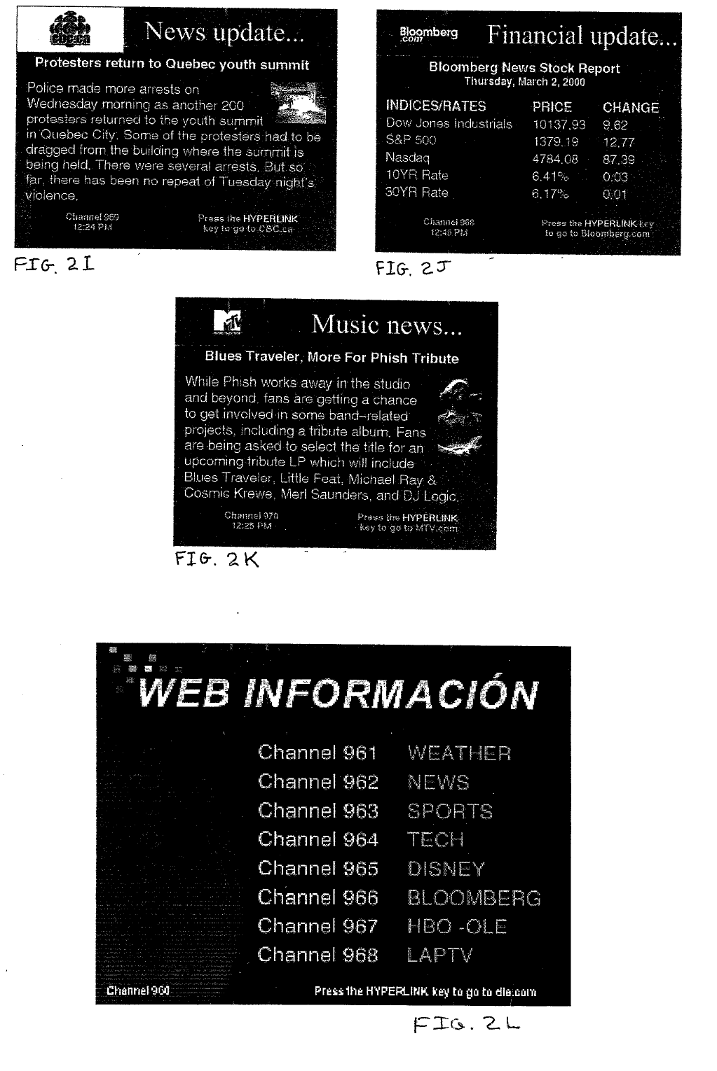

With reference to FIGS. 2A-2L, a number of exemplary screen captures are illustrated showing the types of information that may be provided using the information service system 10. These include, for example, weather, news, sports, children's programs, entertainment, technology, finance and music, and each is assigned to a particular digital channel that may be selected by the viewer. Each channel preferably displays one or more screens of information. If plural screens of information are to be displayed, these are preferably cycled periodically (e.g., once every 20 seconds) so that the viewer may view all of the screens of information for any given channel within an acceptably short period of time while still providing enough time for the viewer to comfortably review each information screen. FIG. 2L illustrates a menu page that lists all of the information service channels, including a brief description of the information available on each channel (note, the channel listings in FIG. 2L are exemplary and do not match up with all of the example channels shown in FIGS. 2A-2K). Preferably, the listing for each channel can be highlighted by the viewer using their remote control or other input device, to facilitate switching to the desired channel.

As illustrated, each screen of information makes reference to a Hyperlink key that enables the viewer to access the Internet web site for the particular information service partner that provides the presently viewed information. This technique is known more specifically as CHANNEL HYPERLINKING in which a viewer may access information from the Internet or another information provider, that is related to the content of the presently viewed information. This concept is disclosed, for example, in U.S. Pat. No. 5,961,603, which issued on Oct. 5, 1999 to Gerard Kunkel, et al., and is hereby incorporation by reference.

With the foregoing arrangement, a viewer can quickly browse through the information service channels, and receive updated information on a plurality of topics. If the viewer should desire additional information, they can hyperlink to the web site for the particular partner, or can switch to the normal broadcast channel for that partner if one is available.

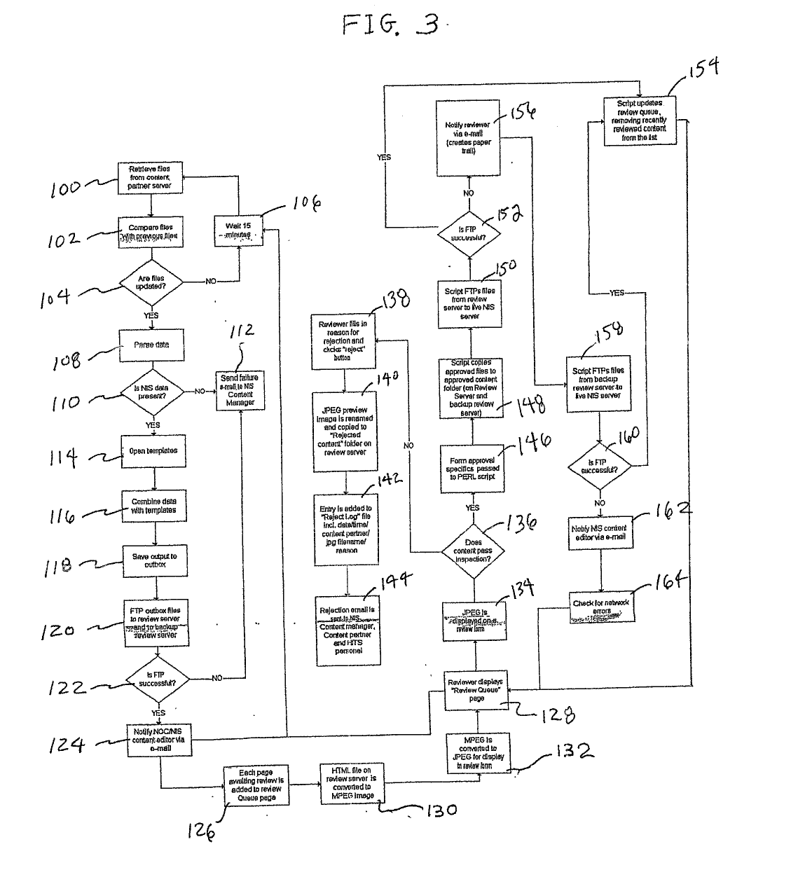

With reference to FIG. 3, a flow chart is illustrated which shows in greater detail, the method by which the preferred embodiment of present invention is implemented. First, at step 100, the information files from the partner server 18 are retrieved and compared, at step 102, with the previously retrieved files to determine whether the files have been updated at step 104. If not, at step 106, the software waits 15 minutes, and returns to step 100 to repeat this process.

If the files have been updated, then data is parsed or packaged at step 108, and sent to the designated one of the inboxes 27 in the central server 24. At step 110, all of the inboxes 27 are checked to see if any information service data is present. If not, a “send failure” message is sent at step 112 to an information service content manager that notifies the manager that the information transfer has failed. If the information service data is present, the central server program 28 opens the HTML templates at step 114, and combines the information service data with the templates at step 116 to form the script pages. The scripts are then saved at step 118 to the outbox 29 in the central server 24, and are then sent via FTP to the review server 32 and a backup review server at step 120.

At step 122, a query is made to determine whether the FTP was successful. If not, the “send failure” message is sent to the content manager at step 112. If the FTP is successful, the content editor is notified, preferably via e-mail, that new information content is available for review and approval. At this point, a message is sent back to the file retrieval program 22 to begin the 15 minute waiting period at step 106 for the next retrieval of the files from the partner server 18. In addition, each page of new information awaiting review is added to a “Review Queue” page at step 126, and the reviewer displays the “Review Queue” page at step 128.

At step 130, the HTML file on the review server is converted into an MPEG image, and is then converted at step 132 to a JPEG image for display on a review form at step 134. A query is then made at step 136 to determine whether the content passes inspection. If not, the reviewer fills in the reason for the rejection and clicks the “reject” button at step 138. Next, at step 140, the JPEG preview image is renamed and copied to a “Rejected content” folder on the review server 32. In step 142, an entry is added to a “Reject Log” file that includes identification information, including date, time, content partner, JPEG file name and reason. Finally, at step 144, a rejection e-mail is sent to the content manager, content partner and HITS personnel.

Assuming that the content does pass inspection at step 136, the form approvals specifics are passed to the script program at step 146. At step 148, the script program copies approved files to an approved content folder on the review server 32 and the backup review server. In this regard, the script program has the capability of communicating with the review server 32 and the backup server through any suitable conventional firewall arrangement. Next, at step 150, the script program sends the formatted files via FTP from the reviewer server 32 to the live information service server for forwarding to the local headend 14. If the FTP process is successful at step 152, the script program updates the review queue, then removes recently reviewed content from the list at step 154. The program then returns to step 128 to review the next page in the queue. If the FTP is unsuccessful at step 152, then a notification is sent to the reviewer via e-mail at step 154. I this occurs, the script program next sends the files from the backup review server to the live information service server. If this transfer is successful at step 160, then the program returns to step 154. If this second attempt at a transfer is unsuccessful, the content editor is noted via e-mail at step 162 and the network is checked for errors at step 164.

Although the invention has been disclosed in terms of a preferred embodiment, and variations thereon, it will be understood that numerous additional modifications and variations could be made thereto without departing from the scope of the invention as set forth in the following claims.

1. An information service distribution system comprising:
at least a first provider of information to be broadcast to viewers in at least one televison distribution system, said provider including programming which periodically generates one or more information files and stores said files in a provider storage medium;
a central server for receiving said information files from said provider storage medium, said central server including a plurality of storage locations for storing said information files;
a provider server for periodically transferring said information files in said provider storage medium to said central server;
a least a first local server for receiving said files from said central server and sending said files to a corresponding cable headend in a television distribution system for broadcast to viewers in said televison distribution system; and
programming in said central server for periodically checking whether information files are present in any of said storage locations, and transferring any such files to said local server.

2. The system of claim 1, wherein said provider server includes programming that periodically checks whether said provider has transferred updated files to said provider storage medium, and transfers any such updated files to said central server.

3. The system of claim 1, wherein said provider server communicates with said central server and said central server communicates with said at least first local server through a communications medium selected from the group comprising the Internet, a wireless link, a satellite, a telephone line and a dedicated communications line.

4. The system of claim 1, wherein said central server further includes programming for checking whether said files in said storage locations have been updated by said provider server and sending any of said files that have been updated to said at least first local server.

5. The system of claim 4, wherein said central server programming includes script programming written in a language selected from the group including PERL, C, JAVA, VB and PYTHON for formatting said information files into files of the type selected from the group including HTML, GIF and JPEG, and sending said files via a designated protocol to said at least first local server.

6. The system of claim 1, wherein said local server further includes an editor for facilitating review and approval of the content of said files prior to being sent to said headend.

7. The system of claim 1, further including a private network for interfacing said local server to said headend.

8. The system of claim 1, wherein said provider provides information of the type selected from the group comprising weather, news, sports, children's programs, entertainment, technology, finance and music information.

9. An information service distribution system comprising:
at least a first provider of information to be broadcast to viewers in at least one televison distribution system, said provider including programming which periodically generates one or more information files and stores said files in a provider storage medium;
a central server for receiving said information files from said provider storage medium, said central server including a plurality of storage locations for storing said information files;
a provider server for periodically transferring said information files in said provider storage medium to said central server, said provider server includes programming that periodically checks whether said provider has transferred updated files to said provider storage medium, and transfers any such updated files to said central server;
a least a first local server for receiving said files from said central server and sending said files to a corresponding cable headend in a television distribution system for broadcast to viewers in said televison distribution system, said local server including an editor for facilitating review and approval of the content of said files prior to being sent to said headend. and
programming in said central server for periodically checking whether said files in said storage locations have been updated by said provider server and transferring any such files to said local server.

10. The system of claim 9, wherein said provider server communicates with said central server and said central server communicates with said at least first local server through a communications medium selected from the group comprising the Internet, a wireless link, a satellite, a telephone line and a dedicated communications line.

11. The system of claim 10, wherein said central server programming includes script programming written in a language selected from the group including PERL, C, JAVA, VB and PYTHON for formatting said information files into files of the type selected from the group including HTML, GIF and JPEG, and sending said files via a designated protocol to said at least first local server.

12. The system of claim 9, further including a private network for interfacing said local server to said headend.

13. The system of claim 9, wherein said provider provides information of the type selected from the group comprising news, sports, weather and stock information.

14. A method for broadcasting information in a televison distribution system comprising the steps of:
providing at least a first provider of information to be broadcast to viewers in at least one televison distribution system, said provider periodically generating one or more information files to be transferred to at least one televison distribution system and storing said information files in a provider storage medium;
periodically transferring said information files stored in said provider storage medium to one or more of a plurality of storage locations in a central server;
periodically checking whether any information files are stored in any of said storage locations, and if so, sending any such information files to at least one local server; and
sending said information files from said local server to a cable headend in a television distribution system for broadcast to viewers in said televison distribution system.

15. The method of claim 14, wherein said step of periodically transferring said information files stored in said provider storage medium to one or more of a plurality of storage locations in a central server further comprises checking whether said provider has transferred updated files to said provider storage medium, and transferring said information files only if they have been updated.

16. The method of claim 14, wherein said step of sending said information files from said local server to a cable headend in a television distribution system for broadcast to viewers in said televison distribution system further includes the steps of reviewing the content of said files prior to being sent to said headend.

17. The method of claim 16, wherein said step of reviewing the content of said files further comprises sending said files to said headend only if the content of said files is approved, and if not, sending a message to said central server indicating that said information files have not been approved.

18. The method of claim 16, further comprising the steps of formatting said information files in said central server as HTML pages, sending said HTML pages via a designated protocol to said at least first local server, converting said HTML pages to one or more JPEG files for review and reconverting said JPEG files to one or more HTML pages after they have been reviewed and are ready to send to said headend.

19. The method of claim 14, further comprising the steps of formatting said information files in said central server as image files of the type selected from the group including HTML pages, GIF and JPEG files, and sending said image files via a designated protocol to said at least first local server.

20. The method of claim 14, wherein said provider provides information of the type selected from the group comprising weather, news, sports, children's programs, entertainment, technology, finance and music information.
